(19) United States
(12) Patent Application Publication
(10) Pub. No.: US 2014/0339800 A1
(43) Pub. Date: Nov. 20, 2014

(54) Snow and Debris Accumulation Prevention System

(71) Applicant: James Drew Siddons, Marlton, NJ (US)

(72) Inventor: James Drew Siddons, Marlton, NJ (US)

(21) Appl. No.: 13/893,900

(22) Filed: May 14, 2013

(51) Int. Cl. B60J 11/06

(52) U.S. Cl. CPC B60J 11/06
USPC 280/768

(57) ABSTRACT

A snow and debris accumulation prevention system for vehicles having a vehicle body and tires, utilizes a flexible, easily removeable, integral continuous length material curtain, or a curtain made up of interconnected material sections. The curtain has a top edge and a bottom edge. A sleeve runs through the length of the top edge. A tautly maintained line extends through the sleeve. The line is configured to be hung on hooks on the vehicle body, such that the curtain is suspended from the hooks, completely circumscribes the vehicle body, and extends over, completely covering the vehicle tires. The bottom edge of the curtain also has a sleeve containing weighted dunnage, to ensure that the curtain is maintained in a fixed position, suspended down from and circumscribing the vehicle body and completely covering its tires.

### BACKGROUND OF THE INVENTION

During a winter storm, the accumulation of snow and ice around the tires of a vehicle is more than just a mere inconvenience. Certainly the need to clear such obstructions away must be accomplished before the vehicle can be moved; however, unless the accumulation is totally removed from around the tires, there exists an increased safety risk when attempts are made to actually move the vehicle. The same problems and concerns are present when vehicle tires are surrounded by other hazards like thick foliage or man-made debris which may build up around vehicles.

There is currently no system specifically designed to protect the tires of vehicles from the accumulation of snow, ice, and other debris which could create a potentially dangerous and, at the very least, a most inconvenient situation.

### SUMMARY OF THE INVENTION

It is thus the object of the present invention to provide a snow and debris accumulation prevention system which efficiently and effectively protects vehicle tires from the build up of snow, ice, and other obstructive debris.

It is another object of the present invention to provide a snow and debris accumulation prevention system which is easy and simple to install on a vehicle and just as easy and simple to remove, pack, and transport for storage.

It is still another object of the present invention to provide a snow and debris accumulation prevention system which comprises a limited number of components and so is economical to manufacture.

These and other objects are accomplished by the present invention, a snow and debris accumulation prevention system for vehicles having a vehicle body and vehicle tires. The system utilizes a flexible, easily removeable, integral continuous length material curtain, or a curtain made up of interconnected material sections. The curtain has a top edge and a bottom edge. A sleeve runs through the length of the top edge. A tautly maintained line extends through the sleeve. The line is configured to be hung on hooks on the vehicle body, such that the curtain is suspended from the hooks, completely circumscribes the vehicle body, and extends over, completely covering the vehicle tires. The bottom edge of the curtain also has a sleeve containing weighted dunnage, to ensure that the curtain is maintained in a fixed position, suspended down from and circumscribing the vehicle body and completely covering its tires.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is a side view of the snow and debris accumulation prevention system of the present invention, including an integral, continuous length material curtain, mounted on a vehicle, in this case a truck trailer.

FIG. 2 is a top view of the snow and debris accumulation prevention system of the present invention shown in FIG. 1.

FIG. 3 is a side view of an alternate embodiment of the snow and debris accumulation prevention system of the present invention, including a curtain comprised of interconnected material sections, mounted on a truck trailer.

FIG. 4 is a top view of the embodiment of the snow and debris accumulation prevention system of the present invention shown in FIG. 2.

FIG. 5 is a detailed view taken from FIG. 4.

FIG. 6 is a detailed view of the hook attachment system contemplated for use in the system of the present invention, shown suspending a portion of the curtain.

### DETAILED DESCRIPTION OF THE INVENTION

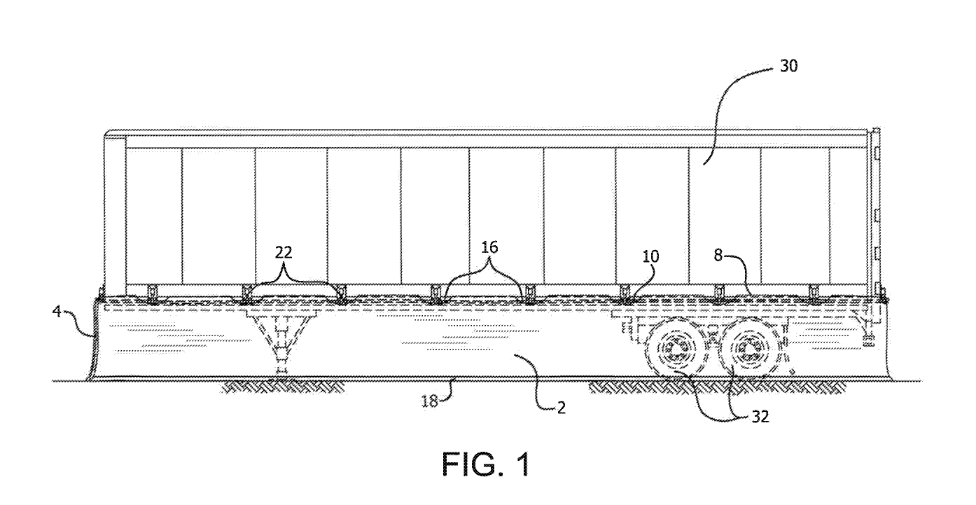

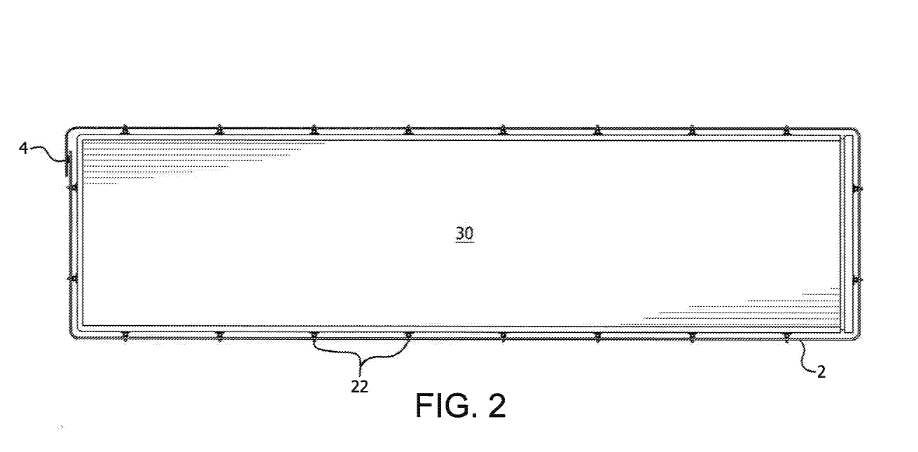

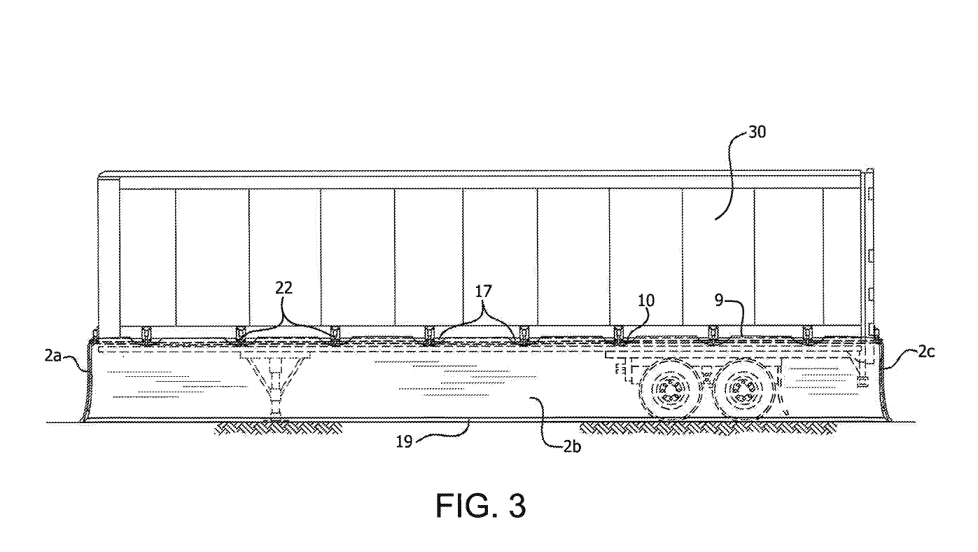

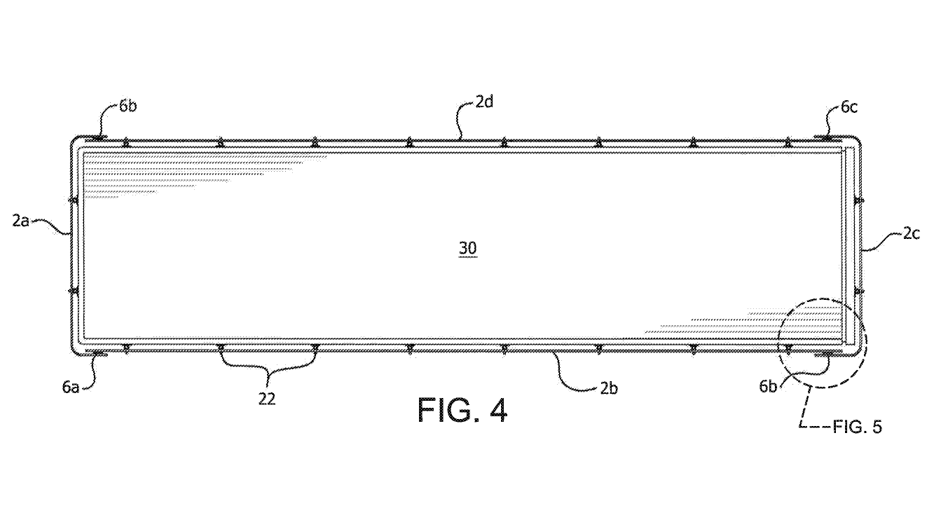

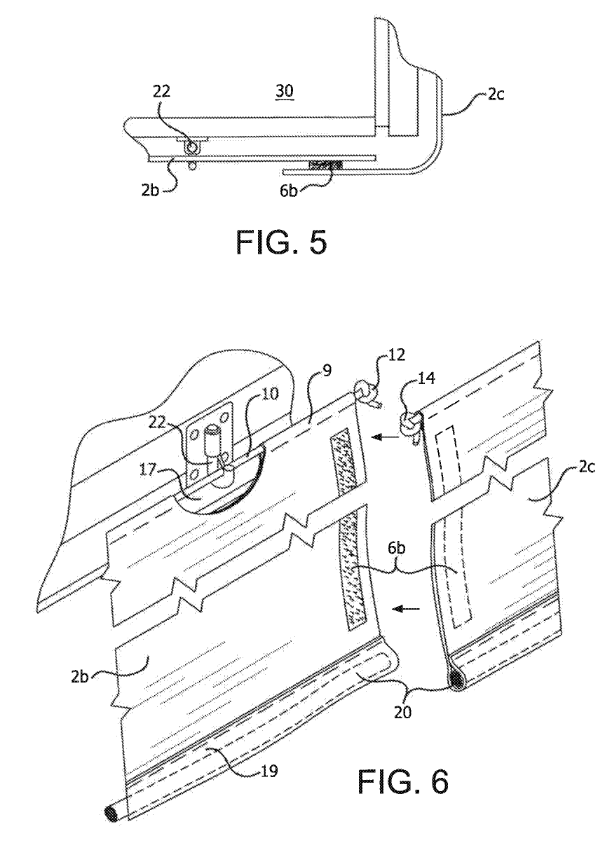

The snow and debris accumulation prevention system of the present invention comprises curtain 2 made of a flexible, yet sturdy tarpaulin type material, e.g. canvas or its equivalent. Curtain 2 is of sufficient length so as to completely circumscribe the body of a vehicle, like truck trailer 30, and completely cover its tires 32. Curtain 2 is an integral, continuous length of material, secured around truck body 30 by means of a Velcro® type fastener or equivalent attachment means 4. See FIGS. 1 and 2. The curtain of the present invention can also be made up of front, rear and lateral sections 2a, 2b, 2c, and 2d which, when they are secured together at their respective ends by Velcro® type fasteners or equivalent attachment means 6a, 6b, 6c, and 6d, also completely circumscribe vehicle body 30. See FIGS. 3-5.

Curtain 2 and, alternatively, the curtain comprised of sections 2a, 2b, 2c and 2d, each comprise upper sleeves 8 or 9 which extend the length of the top edge of the curtain or curtain sections. Line 10, which could be high strength rope, wire or equivalent, extends through sleeve 8 or 9. Line 10 is maintained in a straight, taut condition in sleeves 8 or 9 by means of knotted line ends or similar line holding devices 12 and 14. Cut-out sections 16 or 17 are located at spaced intervals on sleeves 8 or 9.

Curtain 2 and the curtain having sections 2a, 2b, 2c, and 2d also comprise sleeves 18 or 19 which extend the length of the bottom edge of the curtain. Weighted dunnage or ballast material 20 is located within sleeves 18 or 19. Dunnage material 20 can be permanently installed within the sleeves or the sleeves could have open ends which would permit the placement of dunnage or its removal when curtain 2 or the curtain with sections 2a, 2b, 2c, and 2d were not being used.

Hooks 22 are secured to vehicle body 30 in spaced relation to each other. The spacing between hooks 20 corresponds to the spacing of cut-out sections 16 or 17 of curtain 2 or the curtain with sections 2a, 2b, 2c, and 2d. It is anticipated that hooks 22 will be swivel type hooks which rotate outward when the curtain or the curtain with sections 2a, 2b, 2c, and 2d are to be installed and rotate inward, so as to be substantially flush with the side of vehicle body 30 during all other times.

In use, curtain 2 or the curtain with sections 2a, 2b, 2c, and 2d are installed on vehicle body 30 by positioning line 10 on hooks 22, at cut-out sections 16 or 17. Curtain 2 or the curtain with sections 2a, 2b, 2c, and 2d are sized so that when suspended down from vehicle body 30 by means of hooks 22, they extend over and completely cover vehicle body tires 32. Dunnage material 20 located in sleeves 16 or 17 ensures that curtain 2 or the curtain with sections 2a, 2b, 2c and 2d will be maintained in fixed position, suspended down from and circumscribing vehicle body 30 and completely covering tires 32. In this position, tires 32 are well protected from accumulating snow, ice, foliage which may grow in the area, or man-made debris.

When vehicle body 30 is to be put into service, curtain 2 or the curtain with sections 2a, 2b, 2c, and 2d are simply removed from hooks 22 and stored by rolling the full length of curtain or curtain sections around their respective sleeves, when dunnage material 20 is permanently installed therein, or removing the dunnage material and folding-up the full length of curtain or the four sections of the curtain.

While the system of the present invention has been disclosed and described for use on a truck trailer, the use of the system is not to be considered so restricted. It is contemplated that the system can readily be used on any vehicle where the prevention of accumulating weather, nature, or man-made hazards, obstructions, debris, or the like around vehicle tires is necessary. Similarly, while the use of swivel hooks to suspend the length of curtain or sections of the curtain have been disclosed and described, any equivalent suspension device can be utilized in the system.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A snow and debris accumulation prevention system for vehicles having a vehicle body and vehicle tires, said system comprising:
a flexible, removeable curtain having a top edge and a bottom edge, the curtain being suspended from and completely circumscribing the vehicle body, said curtain further extending over and completely covering the vehicle tires;
vehicle attachment means along the top edge of the curtain for suspending the curtain from the vehicle body; and
curtain attachment means on the vehicle body for maintaining the vehicle attachment means on the vehicle body, whereby when the vehicle attachment means is maintained on the curtain attachment means, the curtain is suspended from and completely circumscribes the vehicle body and further extends over and completely covers the vehicle tires.

2. The system as in claim 1 wherein the vehicle attachment means comprises a sleeve extending the length of the top edge of the curtain and a tautly maintained line extending through the sleeve.

3. The system as in claim 2 wherein the curtain attachment means comprises a hook connected to the vehicle body, the taut line being located on the hook to suspend the curtain from the vehicle body.

4. The system as in claim 1 wherein the curtain attachment means comprises a hook connected to the vehicle body, the vehicle attachment means being located on the hook to suspend the curtain from the vehicle body.

5. The system as in claim 1 further comprising a sleeve extending the length of the bottom edge of the curtain and dunnage means located within the sleeve for maintaining the curtain in a fixed position suspended down from and completely circumscribing the vehicle body and extending over and completely covering the vehicle tires.

6. The system as in claim 3 further comprising a sleeve extending the length of the bottom edge of the curtain and dunnage means located within the sleeve for maintaining the curtain in a fixed position suspended down from and completely circumscribing the vehicle body and extending over and completely covering the vehicle tires.

7. The system as in claim 1 wherein the curtain comprises an integral, continuous length of material, secured at its ends by fasteners.

8. The system as in claim 1 where the curtain comprises separate front, rear, and lateral sections and curtain section connection means for securing the sections one to each other to form a single continuous length of curtain.

9. The system as in claim 8 wherein the curtain section connection means comprises Velcro® type fasteners.

10. The system as in claim 7 wherein the vehicle attachment means comprises a sleeve extending the length of the top edge of the curtain and a tautly maintained line extending through the sleeve.

11. The system as in claim 8 wherein the vehicle attachment means comprises a sleeve extending the length of the top edge of the curtain and a tautly maintained line extending through the sleeve.

12. The system as in claim 10 wherein the curtain attachment means comprise hook connected to the vehicle body, the taut line being located on the hook to suspend the curtain from the vehicle body.

13. The system as in claim 11 wherein the curtain attachment means comprises a hook connected to the vehicle body, the taut line being located on the hook to suspend the curtain from the vehicle body.
